(19) United States
(12) Patent Application Publication
(10) Pub. No.: US 2008/0101222 A1
(43) Pub. Date: May 1, 2008

(54) Lightweight, Time/Space Efficient Packet Filtering

(76) Inventor: David Alan Christenson, Fergus Falls, MN (US)

Correspondence Address: WOOD, HERRON & EVANS, L.L.P. (IBM), 2700 CAREW TOWER, 441 VINE STREET, CINCINNATI, OH, 45202, US

(21) Appl. No.: 11/554,057

(22) Filed: Oct. 30, 2006

(51) Int. Cl. H04L 12/26

(52) U.S. Cl. 370/230; 370/392

(57) ABSTRACT

Variable-length tuples are used in packet filter rules to optimize time and/or space efficiency in a packet filtering system. The variable-length tuples only store the parameters necessary to implement a rule, and desirably omit any unnecessary parameters. An index field may also be provided in each rule to identify the number and types of parameters stored in the tuple for the rule, with the index field optionally used to map to an optimized rule checking function for that rule.

### FIELD OF THE INVENTION

The invention generally relates to packet filtering. More specifically, it relates to processing filter rules to implement a security policy.

### BACKGROUND OF THE INVENTION

The Internet, and computer networking in general, are becoming increasingly important in today's society. However, the users on a network who access the Internet can unknowingly create vulnerabilities for less scrupulous individuals to exploit. As a result, network security is becoming increasing important as Internet usage increases. Network security relates to the protection of networks and their services from unauthorized modification, destruction, or disclosure. Assaults upon a network can range from denial of service attacks, unauthorized access attacks, data destruction attacks, and many others. Any one of these attacks that breach the network can cripple any home or business network in an instant. Therefore, robust network security schemes are needed. One such type of network security scheme involves Internet Protocol (IP) packet filtering.

IP is a data oriented procedure or protocol that is used when relaying or communicating data across a network that implements packet switching. With packet switching, data is communicated in discrete units of information, also known as packets, which are utilized to maximize the bandwidth available in a given network. IP, which is a network layer protocol, is often used with a higher-level transport protocol, e.g., Transmission Control Protocol (TCP), User Datagram Protocol (UDP), Internet Control Message Protocol (ICMP), Datagram Congestion Control Protocol (DCCP) or Stream Control Transmission Protocol (SCTP). A large bulk of the data communicated over private networks, as well as over the Internet, relies on the combination of the TCP/IP protocols.

In a network security scheme, IP packet filtering is used to check each IP packet that is going to be sent from or arriving at a gateway system in a communications network, e.g., an Internet firewall, an Internet Service Provider (ISP), a router, a switch, or potentially any other component coupled to a network. Based upon the results of the check of the IP packet, the gateway makes a decision as to whether the packet should be discarded or allowed to continue, often referred to as “deny” and “permit.” Furthermore, in many IP packet filtering schemes, the decision logic used to determine whether to deny or permit a packet is encoded in a set of filter rules.

The filter rules used in IP packet filtering are commonly implemented using an ordered list of rules processed sequentially in a predetermined order. Processing for an IP packet continues until the packet is explicitly permitted, explicitly denied, or there are no more rules, in which case the packet is usually denied. Typically, a number of filter rules must be used to cover all types of packets that would ordinarily be received by a gateway. Often these filter rules are implemented in a rules file that is created by a network administrator.

Efficiency and quickness are often paramount in the design of any IP packet filtering design. The high volume of IP packets a typical gateway system will handle each day, not to mention the fairly large number of filter rules that may have to be processed for each IP packet, can place great demands on a gateway system. In addition, in some gateway systems, e.g., smaller Internet enabled devices such as PDA's and mobile phones, filtering actions must be as time and space efficient as possible due to the limited CPU speed and small memory size of such devices. Even in environments where dedicated hardware is used to offload packet filtering from a main CPU for a device, time and space efficiency are still of concern due to the desire to minimize overhead and maximize networking performance.

Some conventional IP packet filtering systems represent filter rules using fixed-length n-tuples (e.g., 5-tuple or 6-tuple), with potentially multiple tuples per filter rule. Each tuple typically stores multiple parameters that in essence define the rule. However, by being of fixed size, tuples are often utilized inefficiently, particularly for relatively simple rules that only require one or two parameters. If, for example, a filter rule is defined to permit all TCP packets, the only parameter that is relevant to the rule is the protocol with which a packet is associated. Other parameters that may be required for other rules, e.g., source and/or destination address, source and/or destination port, direction (incoming/outgoing), etc. are not relevant to such a rule. Nonetheless, when using fixed-length n-tuples, each tuple must be allocated space for all possible parameters, and thus always must account for a worst case scenario from a space standpoint. Fixed-length rules therefore are often highly space inefficient.

In addition, many conventional IP packet filtering systems rely on multiple tuples and logic functions that are potentially called for each rule. By doing so, some rules are additionally time inefficient, thus increasing processing overhead and reducing network performance.

Therefore, a need exists for a more space and time efficient process for performing IP packet filtering.

### SUMMARY OF THE INVENTION

The invention addresses these and other problems associated with the prior art by providing an apparatus, program product, and method that utilize variable-length tuples to represent packet filtering rules. The variable-length tuples only store the parameters necessary to implement a rule, and desirably omit any unnecessary parameters. Consequently, the space efficiency of each filter rule is optimized.

Furthermore, in some embodiments consistent with the invention, each filter rule includes an index field that identifies a set or subset of parameters that are associated with the filter rule, and consequently both the number and the identity of the parameters specified in the tuple associated with the filter rule. In still further embodiments, the index field may additionally be used to map each filter rule to a specific rule checking function that is optimized for that particular filter rule. Consequently, the rule checking performed with respect to each rule may be optimized, thus additionally maximizing the time efficiency of each filter rule.

Therefore, consistent with one aspect of the invention, packet filtering is implemented using a set of filter rules where the filter rules in the set include variable-length tuples. In response to receipt of a packet, a first filter rule among the set of filter rules is accessed, and an action is selectively performed on the packet based upon the first filter rule.

Consistent with another aspect of the invention, a filter rule set may be generated for use in packet filtering. The filter rule set may be generated by, for each of a plurality of filter rules, identifying from among a plurality of parameters against which a packet may be tested, at least a subset of the plurality of parameters against which a packet will be tested by such filter rule. Once the parameters are identified, the filter rule set may be generated by generating variable-length tuples for the plurality of filter rules, with the tuple generated for each filter rule including only those identified parameters against which a packet will be tested by such filter rule.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a networked computer system implementing packet filtering consistent with the invention.

FIG. 2 is a block diagram illustrating the compilation and interpretation of filter rules in the networked computer system of FIG. 1.

FIG. 3 is a block diagram of an exemplary set of filter rules capable of being implemented in the networked computer system of FIG. 1.

FIG. 4 is a block diagram of an exemplary format for a binary variable-length tuple for use in the networked computer system of FIG. 1.

FIG. 5 is a block diagram of an exemplary layout of an index bitmap for use in the networked computer system of FIG. 1.

FIG. 6 is a block diagram of an exemplary set of compiled rules incorporating variable-length tuples generated for the example filter rules of FIG. 3.

FIG. 7 is a block diagram of a set of C declarations for the data structures utilized in rule checking the compiled rules in the networked computer system of FIG. 1.

FIG. 8 is a block diagram of an exemplary function table and the associated rule checking functions used to process the example filter rules of FIG. 3.

FIG. 9 is a block diagram of an exemplary filter rule search function used in the networked computer system of FIG. 1 to search for a matching filter rule.

### DETAILED DESCRIPTION

The embodiments discussed hereinafter generate variable length tuples for a plurality of filter rules in a filter rule set used to perform IP packet filtering. The tuples are variable length to the extent that different filter rules in the filter rule set are permitted to have tuples of different length, with each tuple storing only those parameters against which a packet will be tested by a particular filter rule. Desirably a tuple for a filter rule will omit any parameters that will not be tested by that filter rule, thus saving the space that would otherwise be wasted were that parameter (or a blank field corresponding to that parameter) incorporated into the tuple.

In addition, each filter rule in a filter rule set consistent with the invention is desirably mapped to a rule checking function that is specifically optimized for that type of filter rule, e.g., to test only those parameters that are included in the tuple for that filter rule. Such mapping may be performed in a number of manners consistent with the invention. In the illustrated embodiment, for example, such mapping may be performed using an index field incorporated into the filter rule. The index field may act as an index or pointer into a function table having entries associated with the rule checking functions that are optimized for different types of filter rules. In addition, in the illustrated embodiment, the index field is additionally used as a content identifier for the filter rule, identifying specifically which parameters are included in the tuple for the filter rule.

For example, an index field may be configured as a bitmap that has a bit position assigned to every possible parameter against which a packet may be tested by any filter rule in the filter rule set. Parameters that are included in a particular tuple for a filter rule are identified by logical “1” values in the respective bit positions in the associated index field.

Consequently, in the illustrated embodiment, when a packet is tested against a filter rule, the index field for the filter rule is accessed to identify the appropriate rule checking function. This function, when called, then accesses the parameters in the tuple for the filter rule and tests the packet against those parameters. Since the rule checking function in such an embodiment is optimized for the particular type of rule identified by the index field, the number and locations of parameters within the tuple is already established for that function, so the function can be optimized to test for only those parameters included in the tuple.

In addition, whenever a packet is found to match the parameters of a filter rule, an action is performed on the packet, with the action optionally specified in an action field for the filter rule. Such an action may include, for example, permitting or denying the packet, logging or journaling data associated with the packet, encrypting or decrypting the packet, notifying a client of a dropped packet, classifying a packet, performing a quality of service (QOS) related operation on the packet, or practically any other type of action that could desirably be taken on a packet as a result of identifying the packet during packet filtering.

Other modifications and variations consistent with the invention will become apparent from the discussion below.

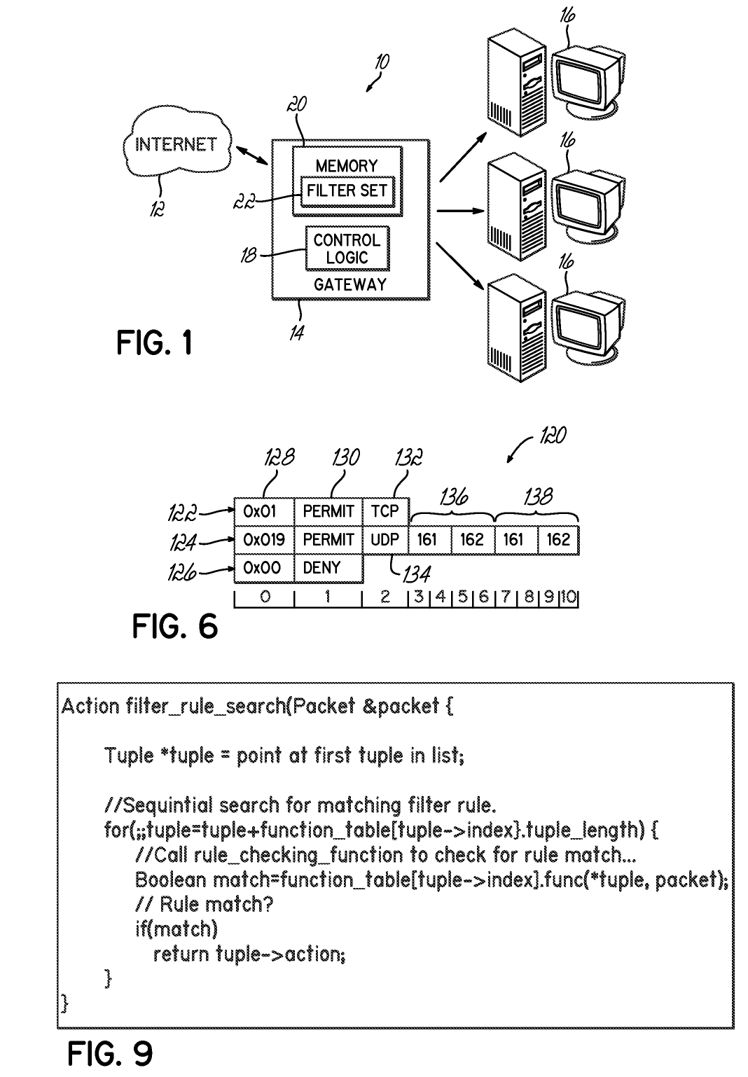

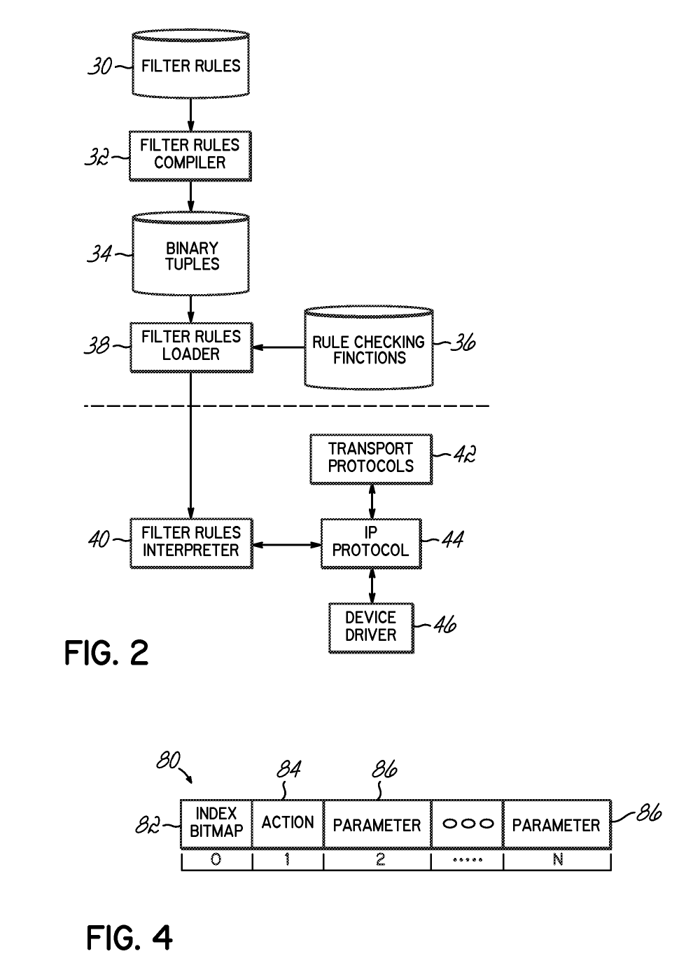

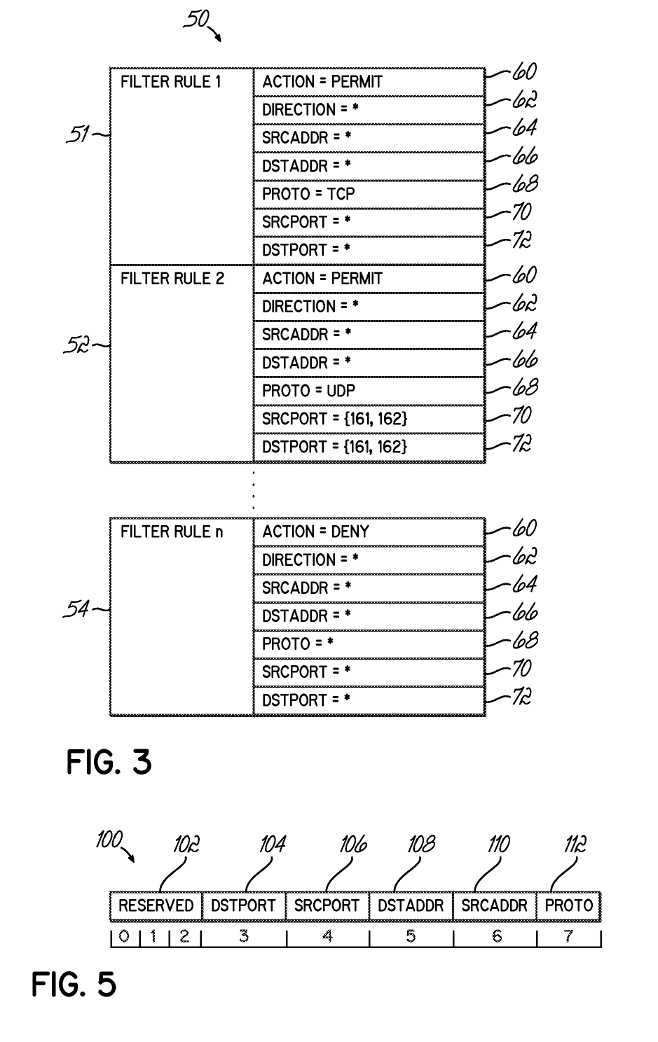

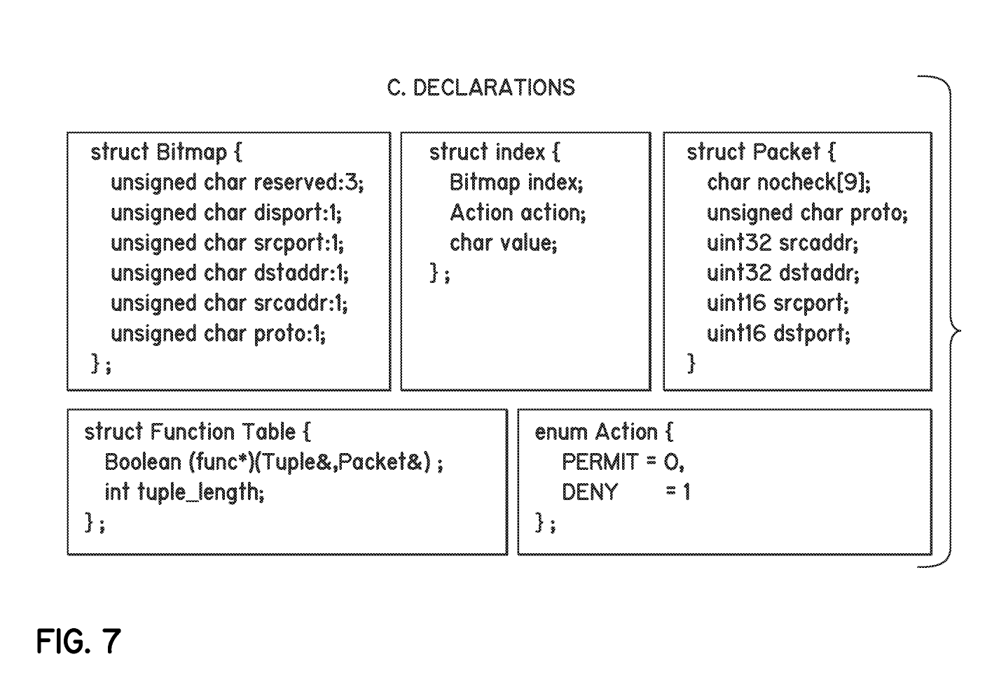

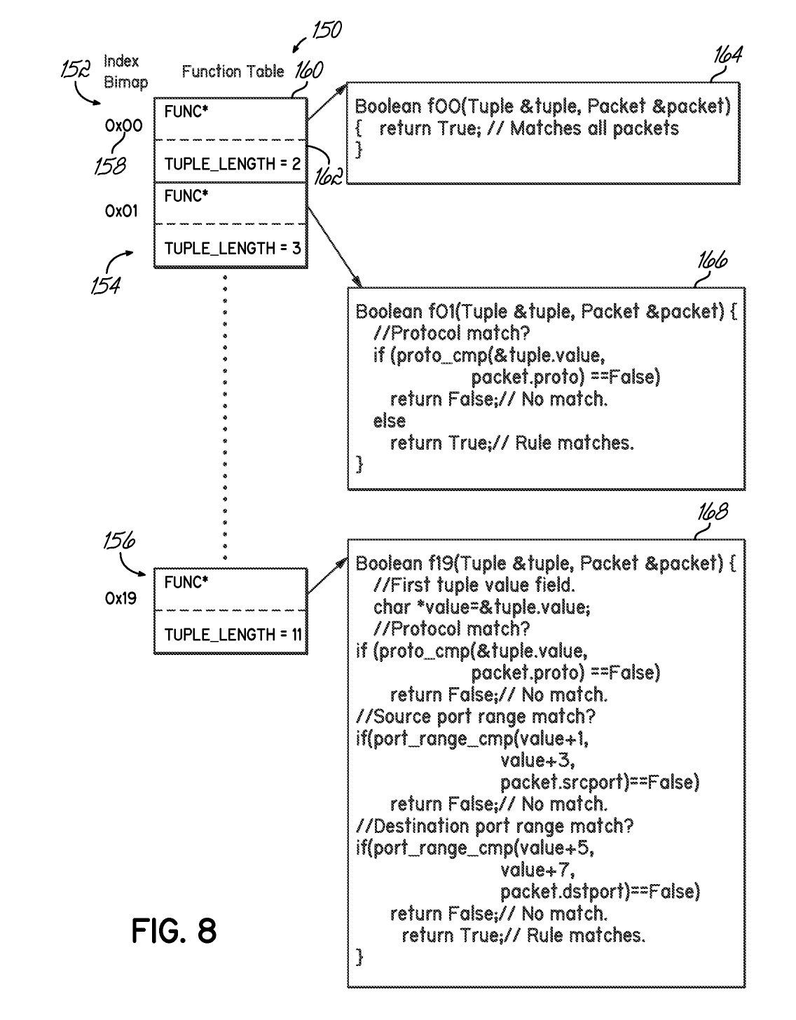

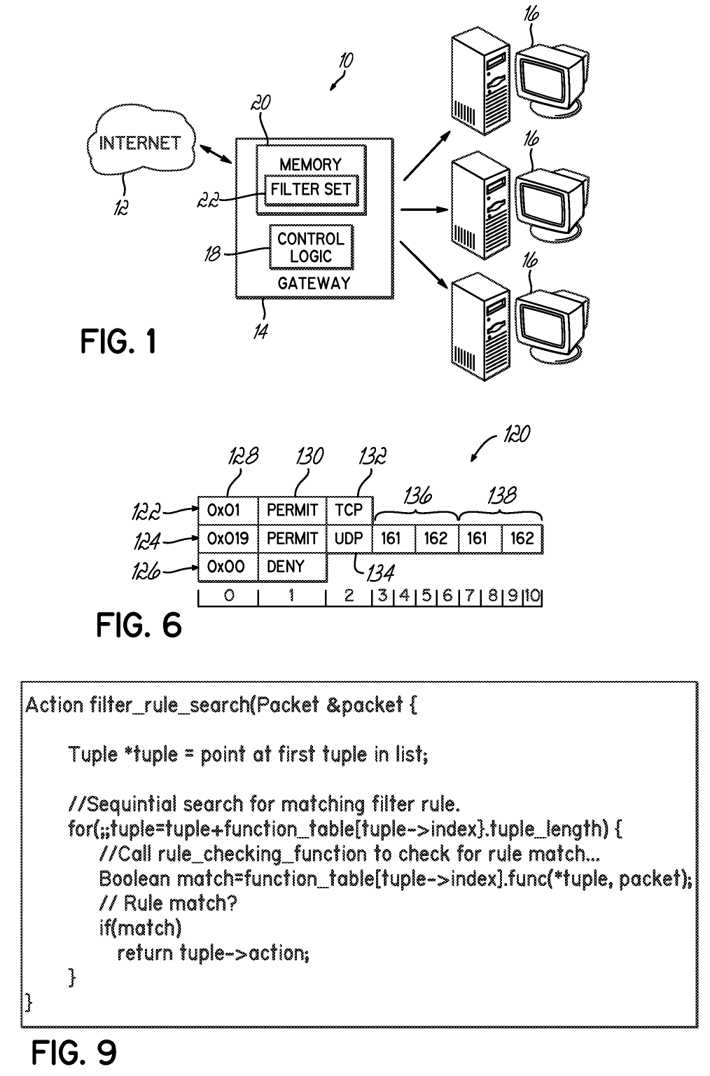

Turning now to the Drawings, wherein like numbers denote like parts throughout the several views, FIG. 1 illustrates a networked computer system 10 within which packet filtering consistent with the invention may be implemented. System 10 in the illustrated embodiment includes a gateway system 14 for interfacing one or more computers 16 with an external network such as the Internet 12. Gateway system 14 may be implemented using any number of electronic devices suitable for performing packet filtering, including, for example, an Internet gateway, a firewall, a network router, a network switch, a server, a general purpose computer, or other network attached electronic device. Gateway system 14 may also be implemented in any client-type device where it is desirable to implement packet filtering, and furthermore, may be used to filter packets on behalf of one or multiple clients.

Computers 16 may be implemented as single-user computers, although the gateway system may be utilized to perform packet filtering on behalf of any number of types of clients, including, for example, servers, portable computers, handheld devices, etc. In addition, while gateway system 14 is shown providing a gateway to the Internet 12, the system may alternatively be used to interface with any type of network, whether public or private.

Gateway system 14 includes control logic 18 coupled to a memory 20, which may represent the random access memory (RAM) devices comprising the main storage of system 14, as well as any supplemental levels of memory, e.g., cache memories, non-volatile or backup memories (e.g., programmable or flash memories), read-only memories, etc. In addition, memory 20 may be considered to include memory storage physically located elsewhere in system 14, e.g., any cache memory in a processor in control logic 18, as well as any storage capacity used as a virtual memory, e.g., as stored on a mass storage device or on another device coupled to system 14. Among other data, memory 20 may be used to store a filter set 22 suitable for use by control logic 18 in performing packet filtering in a manner consistent with the invention.

Control logic 18 may be implemented, for example, using a processor that executes packet filtering program code, e.g., as implemented in firmware, in a kernel, in a network operating system, in a device driver, in an application, etc. In the alternative, control logic 18 may be implemented via specialized hardware or controllers, rather than via a general purpose processor.

It will be appreciated that gateway system 14 may also include a number of inputs and outputs for communicating information externally, e.g., a user interface, one or more network interfaces, and one or more mass storage devices. Furthermore, while a user may interact with gateway system 14 via a dedicated user interface, in many embodiments a user may interact with the gateway system, e.g., for administrative purposes including that of specifying the filter rules to by used by the system, through a remote interface such as a web-based interface. Furthermore, any routines executed to implement the embodiments of the invention, whether implemented as part of an operating system or a specific application, component, program, object, module or sequence of instructions, or even a subset thereof, will be referred to herein as “computer program code”, or simply “program code”. Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to tangible, recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

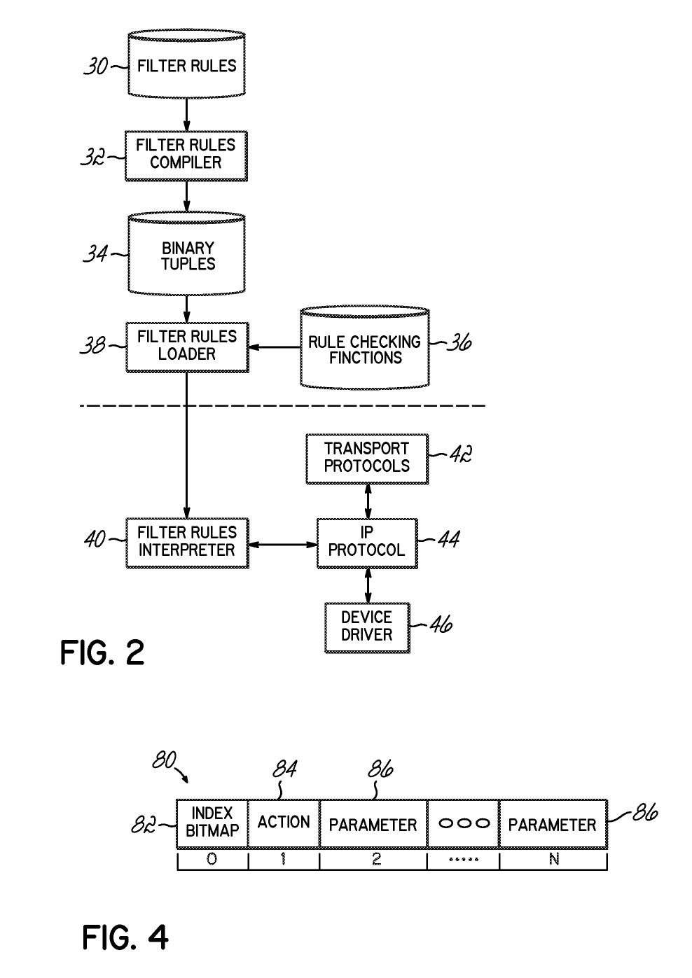

Turning now to FIG. 2, this figure illustrates the principal elements and steps utilized in connection with loading and interpreting a rule set into a kernel of control logic 18 (FIG. 1) for the purpose of implementing IP packet filtering in a manner consistent with the invention. In particular, to load rules from a rule set into a kernel, typically filter rules 30 are first defined by a system administrator, typically in a representation relying on human readable symbolic statements (e.g., FILTER, FILTER_INTERFACE), and stored in a file. The rules may be defined via text statements, or alternatively, via a graphical user interface. The rules are then processed by a filter rules compiler 32, which compiles the symbolic statements to generate variable-length binary tuples 34, which define the filter rules in a second, compiled representation.

Separately, a set of rule checking functions 36 are typically coded by a system administrator (or alternatively, by a developer or other individual separate from the system administrator who defined the filter rules), and are compiled using a standard language compiler. This may be performed in conjunction with the definition of rules, or in the alternative, may be performed at an earlier time and/or preloaded with the operating system or kernel. A filter rules loader 38 then loads the binary tuples 34 and rule checking functions 36 into a kernel level IP filter rules interpreter 40.

Interpreter 40 is connected to an IP protocol layer module 44, which is intermediate one or more higher level transport protocol layer modules 42 (e.g., a TCP module, a UDP module, a ICMP module, etc.) and a lower level device driver 46.

IP protocol layer module 44 utilizes interpreter 40 to implement IP packet filtering for both outgoing and incoming packets. For outgoing packets, a transport protocol layer module 42 sends an outgoing packet to IP protocol layer module 44, which then calls filter rules interpreter 40 to search the filter rules for a matching rule. Once a matching rule is found, interpreter 40 processes the appropriate rule and returns either a PERMIT or DENY action to IP protocol layer module 44. If the action is PERMIT, IP protocol layer module 44 transmits the packet to device driver 46 for output over the associated network device. On the other hand, if the action is DENY, IP protocol layer module 44 discards (i.e., filters) the packet.

For incoming packets, device driver 46 sends an inbound packet to IP protocol layer module 44, which then calls filter rules interpreter 40 to search the filter rules for a matching rule. Once a matching rule is found, interpreter 40 processes the appropriate rule and returns either a PERMIT or DENY action to IP protocol layer module 44. If the action is PERMIT, IP protocol layer module 44 transmits the packet to the appropriate transport protocol layer module 42. Otherwise, if the action is DENY, IP protocol layer module 44 discards (i.e., filters) the packet.

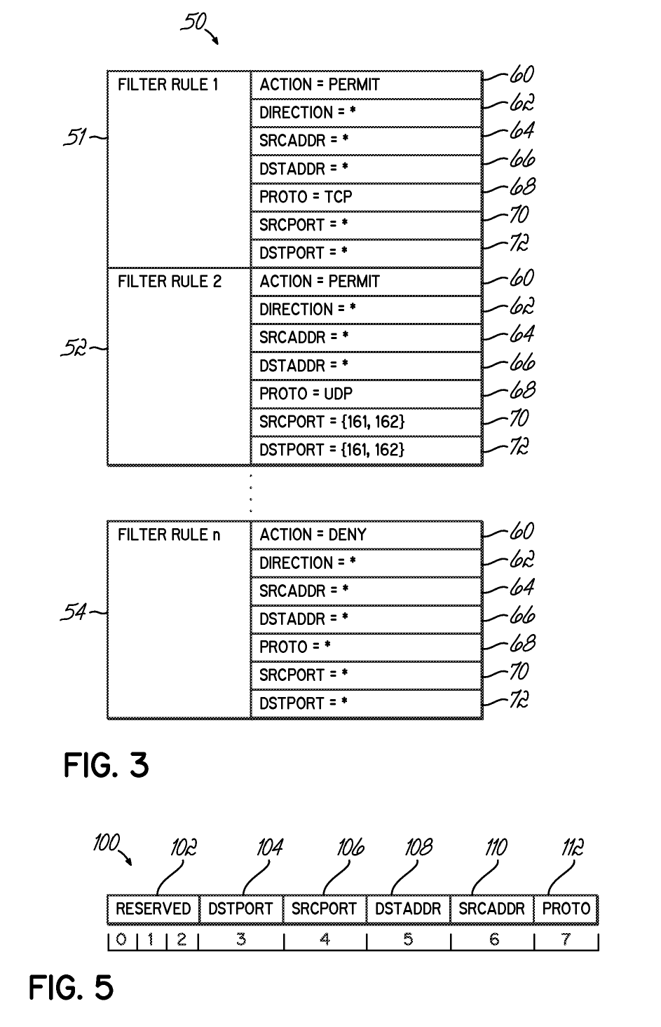

As noted above, filter rules are compiled into variable-length tuples. To further illustrate the format and usage of such tuples, FIG. 3 illustrates a rule set 50 including three exemplary FILTER rule statements 51, 52 and 54 as might be presented to filter rules compiler 32 (FIG. 2). For the purpose of contrasting the use of variable-length tuples with fixed-length tuples as has been used in conventional filtering algorithms, rules 51, 52 and 54 correspond to the example rules set forth in U.S. Pat. No. 6,301,669, which is incorporated by reference herein. In this example, rules 51 and 52 have been explicitly input by a system administrator, while rule 54 is a default “deny” rules that may be generated automatically by filter rules compiler 32 to deny any packets that are not explicitly permitted by any other rule.

Each rule 51, 52, 54 includes an action field 60 that defines the action to be performed in response to a packet matching a set of parameters defined for the rule. The action may be an action such as PERMIT or DENY, or in the alternative, may include any of the other types of actions mentioned above. In addition, each rule includes a direction field 62 that specifies whether a rule applies to incoming packets, outgoing packets, or both. The direction field may be used, for example, to select from among multiple function tables (i.e., separate function tables dedicated to processing incoming and outgoing packets) to which a particular filter rule should link. The direction of a packet typically need not be included as a parameter to be included into a tuple, given that the direction of a packet can generally be ascertained by the interpreter based upon the context in which the packet has been presented to the interpreter by a device driver or a transport protocol layer module. In the alternative, the direction of a packet may be included as a parameter capable of being included in a tuple.

As noted above, each filter rule typically identifies one or more parameters from a set of parameters that a packet is capable of being tested against via packet filtering. In this embodiment, the set of parameters capable of being incorporated into a filter rule includes a number of parameters that may be associated with specific fields in the header of an IP packet. In particular, the set of parameters may include source and destination address fields 64, 66 that specify specific addresses, ranges of addresses, or sets of addresses defined in an IP packet, a protocol field 68 that defines the transport protocol defined in an IP packet, and source and destination port fields 70, 72 that specify specific ports, ranges of ports, or sets of ports defined in an IP packet. It will be appreciated that the set of parameters may vary in different embodiments, and that parameters may be associated with different fields in an IP packet and/or with other characteristics of an IP packet or with the communication of such packets in general, which characteristics may not necessarily be identified in fields of a packet header.

For rule 51, this rule is used to explicitly permit all TCP packets. As such, the rule includes a PERMIT action as specified in field 60, and a protocol field 68 that specifies the TCP protocol. The remainder of the fields (fields 62, 64, 66, 70 and 72) are wildcarded by virtue of the “*” designation. By wildcarding these fields, these fields are designated as being not relevant or necessary for processing of the rule. Furthermore, as will become more apparent below, by wildcarding these fields, the associated parameters for these fields will be omitted from the associated variable-length tuple for the rule, and will not be tested by the associated rule checking function used to process the rule.

For rule 52, this rule is used to permit all UDP packets with a source port of 161 or 162, and a destination port of 161 or 162 (ports commonly used for SNMP (Simple Network Management Protocol) communications). As such, the rule includes a PERMIT action as specified in field 60, and a protocol field 68 that specifies the UDP protocol. In addition, the source and destination port fields 70, 72 specify port ranges of {161, 162}. The remainder of the fields (fields 62, 64 and 66) are wildcarded by virtue of the “*” designation.

For the default deny rule 54, the rule includes a DENY action as specified in field 60, with remainder of the fields (fields 62, 64, 66, 68, 70 and 72) wildcarded by virtue of the “*” designation.

Rules 51, 52 and 54 are logically processed top-to-bottom for each IP packet; so for each packet, if the IP packet matches the rule parameters, then the action defined in the action field 60 is taken. If a given IP packet does not match the first rule 51, it is checked against the next rule 52, and so on, until the last rule (default deny rule 54) is reached. The default deny rule 54 always matches any IP packet, so if this rule is reached, the IP packet is discarded (not allowed to continue).

Now referring to FIG. 4, each filter rule is compiled or translated into a small, variable-length binary tuple 80. In the illustrated implementation, each tuple 80 includes a 2-byte header that includes an index field 82 and an action field 84. This header is followed by a plurality of parameter fields 86, which for any given rule, are provided for each parameter specified, and not wildcarded, by the rule. Put another way, none of the wildcarded field values are stored in the tuple 80, thereby reducing the amount of space required to store the tuple. In the illustrated embodiment, the index and action fields are considered part of each tuple; however, in other embodiments, such fields need not be incorporated into a tuple.

FIG. 5 illustrates one exemplary implementation of index field 82, specifically taking the form of a 1-byte bitmap 100, including a reserved field 102 along with a field, or bit position, for each parameter capable of being defined in a filter rule, and as such, for each parameter against which a packet may be tested. As such, fields 104, 106 are used to designate the presence of destination and source port fields in the tuple, fields 108, 110 are used to designate the presence of destination and source addresses in the tuple, and field 112 is used to designate the presence of a protocol in the tuple. Reserved field 102 is three bits wide in this implementation, and it will be appreciated that the size of this field will vary based upon the number of parameter fields represented in the bitmap.

For a given rule, the appropriate bit is set for each parameter field that is not wildcarded in the rule. In addition, the bit positions may be represented in hexadecimal format, where a hex value of 0x01 indicates that a protocol parameter is in the tuple, a hex value of 0x02 indicates that a source address parameter is in the tuple, a hex value of 0x04 indicates that a destination address parameter is in the tuple, a hex value of 0x08 indicates that a source port parameter is in the tuple, and a hex value of 0x10 indicates that a destination port parameter is in the tuple.

In the illustrated embodiment, index field 82 serves a secondary function, that of as an index into a function table to select an optimal rule checking function for a particular filter rule. It will be appreciated, however, that the designation of the contents of a tuple, and the identification of an appropriate rule checking function, may be handled separately. Furthermore, the use of variable-length tuples need not require separate rule checking functions for each type of rule, whereby no index to a function table would be required.

It will be appreciated that other manners of designating the contents of a tuple may be used as an alternative to the index field described herein. For example, instead of a bitmap, other identifiers may be used to specify the contents of a tuple in a more space efficient manner. Furthermore, in some instances, an index field may simply point to an optimized rule checking function, with the function specifically configured to test a single combination of parameters that are unique to the particular filter rule associated with the function (e.g., for filter rule 52, a rule checking function that checks only the protocol, source port and destination port fields of a packet against the corresponding parameters in the filter rule tuple). In this latter instance, the index field may not specifically identify the contents of a particular tuple.

FIG. 6 next illustrates an exemplary tuple list 120 that may be generated for the example filter rules 51, 52 and 54. This tuple list 120 includes tuples 122, 124 and 126, corresponding respectively to filter rules 51, 52 and 54. Each tuple 122, 124, 126 includes an index field 128 and action field 130, and zero or more parameter fields. For tuple 122, which implements filter rule 51, a single parameter field 132, corresponding to a parameter “protocol=TCP” is included in the tuple, along with an action field 130 with a PERMIT action. Furthermore, given that the protocol parameter is assigned bit position 7 in index field 128, and that this parameter is the only parameter tested by the rule, the index field has a value of 0x01.

For tuple 124, which implements filter rule 52, the tuple includes a protocol parameter field 134, a source port parameter field 136 and a destination port parameter field 138, respectively implementing the parameters “protocol=UDP”, “srcport={161, 162}”, and “dstport={161, 162}.” In addition, based upon the parameters included in the tuple, the index field 128 is assigned a value of 0x19 (0x10+0x08+0x01). The tuple also includes an action field 130 with a PERMIT action.

For tuple 126, which implements filter rule 54, the tuple includes no parameter fields, and accordingly, the index field 128 is assigned a value of 0x00. The tuple also includes an action field 130 with a DENY action, thus implementing the default deny filter rule discussed above.

Note, the tuples are typically arranged in the tuple list in the same order as rules 51, 52 and 54 as defined by the system administrator, and that the tuples are typically searched from top to bottom. Also, assuming that each port range may be represented using starting and ending ports, with two bytes allocated to each port, and with all other fields allocated a single byte, the three filter rules are capable of being stored using only 15 bytes of tuple storage, or an average of 5 bytes per rule. This is in contrast to conventional fixed-length tuple implementations such as 5-tuple rules (144 bytes, or 48 bytes per rule) and 6-tuple rules (70 bytes, or 24 bytes per rule). Consequently, the space efficiency obtained in this implementation is nearly 5 times better than other conventional designs.

It should be noted that the tuples in tuple list 120 may be arranged in contiguous storage, and are shown stacked in FIG. 6 merely for ease of understanding. Moreover, while each field is allocated fixed number of bytes, it will be appreciated that fields could be allocated specific ranges of bits, further improving space efficiency. For example, if only four or fewer protocols were supported, the protocol field could be implemented using as few as two bits.

As noted above the tuples from the tuple list define compiled representations of filter rules. These filter rules are processed by rule checking functions that are optimized for specific types of filter rules. In the illustrated embodiment, the rule checking functions are indexed based upon the index field, and as such, are individually optimized to process any filter rules having the specific combination of parameters identified in the index field for the associated tuple. It will be appreciated, however, that the rule checking functions may be indexed in other manners, and in some instances, rule checking functions may be linked via multiple function tables, and thus indexed by multiple indices. In one exemplary embodiment, for example, separate outgoing and incoming function tables may be used to separately handle incoming and outgoing packets.

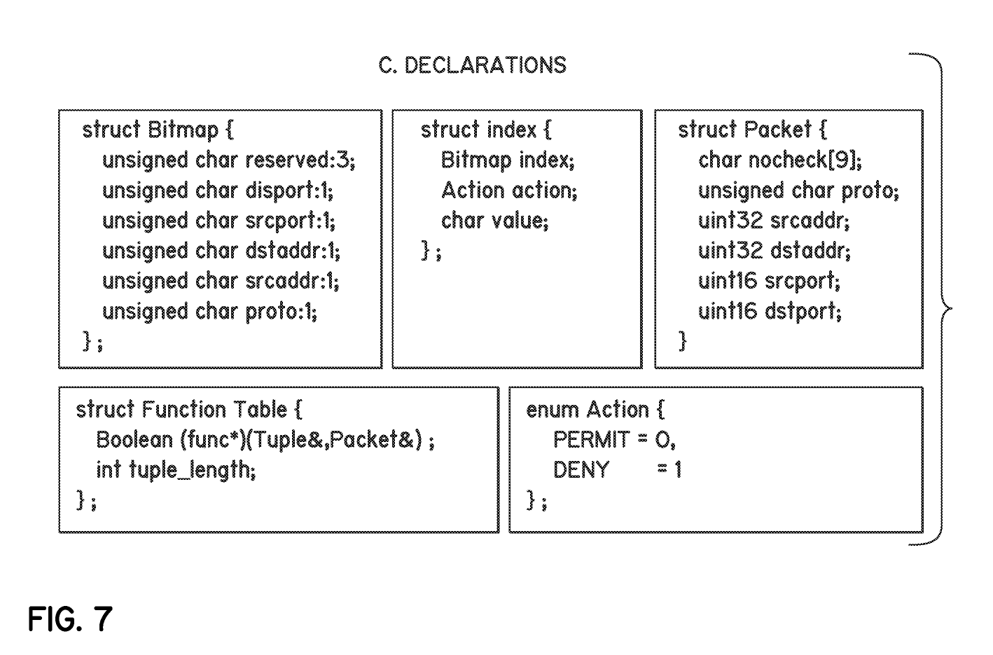

FIGS. 7-9 illustrate one exemplary C-language implementation of the filter rule searching and checking functions, suitable for processing the variable-length tuple filter rules described above. FIG. 7, in particular, illustrates a number of C-language data structure declarations used in the illustrated embodiment.

One such data structure is a Bitmap, which defines the format of the index field in each tuple. Another such data structure is a Tuple, which includes a Bitmap-format index field, an action field having the enumerated values of PERMIT (0) and DENY (1), and zero or more values, representing the parameter fields for the Tuple. Packets are represented in this embodiment in a Packet data structure that includes, in the least, the various fields capable of being tested by a filter rule, i.e., a protocol field, source and destination address fields, and source and destination ports. The source and destination address fields are unsigned 32-bit integers, and the source and destination ports are unsigned 16-bit integers in the illustrated embodiment. It will be appreciated that, with respect to the source and destination addresses, 32-bit integers are sufficient for the purposes of IPv4 addresses. If, as an alternative, IPv6 addresses are supported, the source and destination address fields may be implemented as unsigned 128-bit integers.

Another data structure relied upon in the illustrated embodiment is a FunctionTable data structure, which defines the format for each table entry in a function table, with each table entry including a pointer to an optimized rule checking function that receives as parameters pointers to a tuple and a packet to be tested by the tuple, and a tuple_length value that identifies the number of bytes occupied by the referenced tuple in the tuple list. The latter value may be used to identify the start of the next tuple in the tuple list in the event that a packet does not match the tuple with which the table entry is associated.

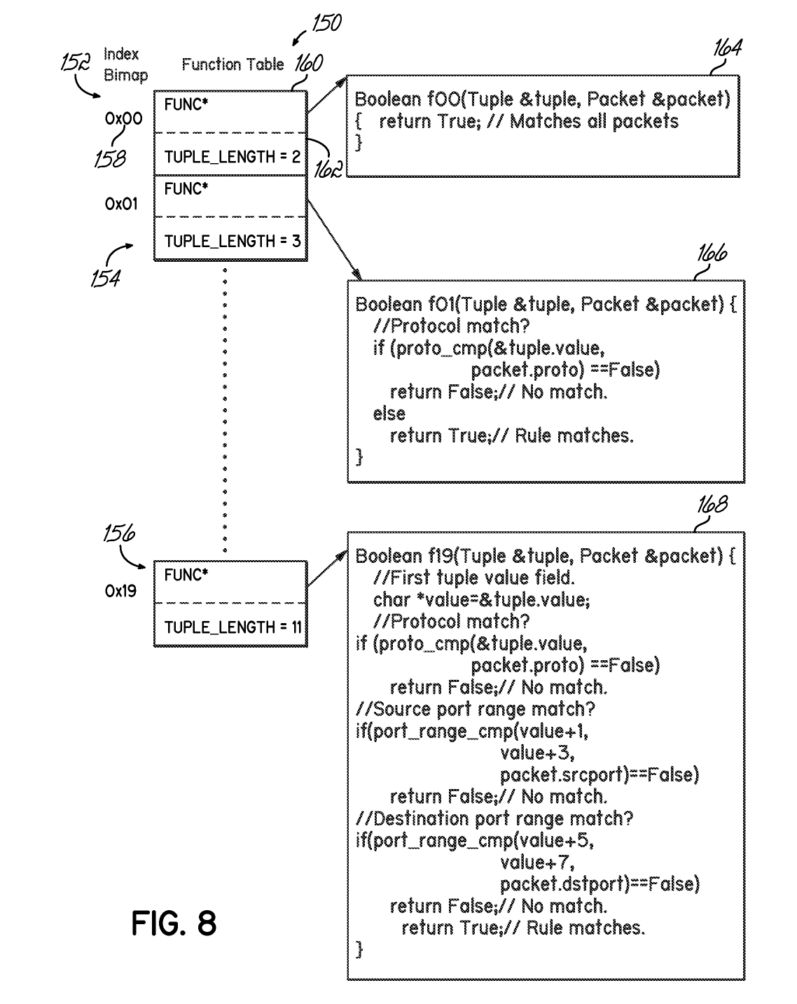

A portion of a function table incorporating the aforementioned data structures is illustrated in greater detail in FIG. 8. In particular, a function table 150 is illustrated including a plurality of table entries 152, 154, 156 respectively corresponding to the three filter rules 54, 51, 52 described above in connection with FIG. 3, and configured to respectively process tuples 126, 122, 124 of FIG. 6. Each table entry 152, 154, 156 is indexed as shown at 158 by the index field of each tuple, and each table entry 152, 154, 156 includes a pointer 160 and a tuple_length variable 162, with the former pointing to an associated C-language optimized rule checking function 164, 166, 168, and with the latter identifying the length (in bytes) of the associated tuple. In the illustrated embodiment, no index field is required in each table entry, as the function table is an ordered array of fixed-size FunctionTable data structures that may be accessed via the index field of each tuple. In other embodiments, however, a separate index field may be provided in each FunctionTable data structure.

It should be noted that each rule checking function 164, 166, 168 is optimized to check a packet only against those parameters that are identified in the tuple representation of the associated filter rule. Accordingly, each rule checking function can be optimized to process a particular type of rule in as efficient manner as possible, and each function can omit operations such as testing for what parameters are specified for a tuple that would otherwise be required were a fixed-length tuple used.

To process a packet using function table 150, a function such as a filter rule search function may be called to process the packet. FIG. 9, for example, illustrates one suitable C-language implementation of a filter rule search function that searches sequentially through the tuple list until a matching filter rule is found. In this regard, the default deny rule, which is the last filter rule defined in the filter rule set, will always match a packet, and thus return a DENY action for any packet that does not match any other rule.

The filter rule search function receives a pointer to a packet to be tested, and generally operates by initially setting a tuple pointer to the first tuple in the tuple list, corresponding to the first filter rule in the filter rule set. A FOR loop then calls the appropriate rule checking function from the function table based upon the index field of the first tuple, with the result returned in the match variable. If a match is encountered, the FOR loop is prematurely terminated and the action specified by the action field of the tuple is returned as the result of the filter rule search function.

Otherwise, if a match is not encountered, the loop increments the tuple pointer by the tuple_length value stored in the currently indexed table entry to update the tuple pointer to point to the next tuple in the tuple list. The packet is then tested against the next tuple using the rule checking function specified in the table entry indexed by the index field of the next tuple. This process continues until a matching rule is found, and the action specified thereby is returned. Given that the last filter rule in the filter rule set is configured to match all packets, it will be appreciated that the filter rule search function will always find a matching rule.

It has been shown that, through the use of variable-length tuples, embodiments consistent with the invention are able to operate with improved space and time efficiency. Furthermore, it will be appreciated by one of ordinary skill in the art having the benefit of the instant disclosure that the variable-length tuples described herein may be utilized in connection with a wide variety of other filtering algorithms to provide more optimized rule processing. For example, various alternative filter rule search functions, e.g., including binary search capabilities, may be used to accelerate the location of a matching rule. In addition, multiple function tables may be defined for different parameter values in some embodiments to further accelerate the filter rule search process, such that such a parameter would not need to be stored in a tuple or tested in an optimized rule checking function.

Various additional modifications to the herein-described embodiments will be apparent to one of ordinary skill in the art having the benefit of the instant disclosure. Therefore, the invention lies in the claims hereinafter appended.

What is claimed is:

1. A method of filtering packets, the method comprising, in response to receipt of a packet:
accessing a first filter rule among a set of filter rules, wherein the filter rules in the set of filter rules include variable-length tuples; and
selectively performing an action on the packet based upon the first filter rule.

2. The method of claim 1, wherein each filter rule in the set of filter rules specifies at least a subset of a plurality of parameters against which a packet is capable of being tested, wherein the tuple for each filter rule includes only those parameters against which a packet will be tested by such filter rule, and wherein selectively performing the action on the packet based upon the first filter rule includes testing the packet against the parameters specified by the first filter rule.

3. The method of claim 2, wherein the tuple for each filter rule omits any wildcarded parameters from the plurality of parameters.

4. The method of claim 2, wherein each filter rule further includes an action field that identifies the action to be performed on the packet in response to the packet matching the parameters included in the tuple for such filter rule.

5. The method of claim 2, wherein each filter rule further includes an index field that identifies those parameters among the plurality of parameters that are included in the tuple for such filter rule.

6. The method of claim 5, wherein the index field for each filter rule includes a bitmap, the bitmap including a bit allocated to each parameter among the plurality of parameters.

7. The method of claim 5, further comprising, after accessing the first filter rule, calling a rule checking function identified by the index field for the first filter rule, wherein the rule checking function is configured to test only those parameters among the plurality of parameters that are included in the tuple for the first filter rule.

8. The method of claim 7, wherein calling the rule checking function includes accessing a function table indexed by the index field, the function table including a plurality of table entries, each entry including a pointer to a rule checking function.

9. The method of claim 8, wherein the tuples for the set of filter rules are stored in a tuple list, wherein each table entry in the function table includes a tuple length field identifying a length of the tuple associated with such table entry, the method further comprising calling a rule search function to search for a matching filter rule in the set of filter rules, wherein the rule search function is configured to access the tuple length field of a table entry in the function table to locate a next tuple in the tuple list.

10. The method of claim 2, wherein each of the plurality of parameters corresponds to a field in a packet.

11. The method of claim 10, wherein the plurality of parameters includes a source address, a destination address, a source port, a destination port, and a protocol.

12. A method of generating a filter rule set for use in packet filtering, the method comprising:
for each of a plurality of filter rules, identifying from among a plurality of parameters against which a packet may be tested, at least a subset of the plurality of parameters against which a packet will be tested by such filter rule; and
generating the filter rule set, including generating variable-length tuples for the plurality of filter rules, wherein the tuple generated for each filter rule includes only those identified parameters against which a packet will be tested by such filter rule.

13. The method of claim 12, wherein generating the filter rule set includes compiling a first representation of the plurality of filter rules into a second, compiled representation that includes the generated variable-length tuples.

14. The method of claim 12, wherein the tuple for each filter rule omits any wildcarded parameters from the plurality of parameters.

15. The method of claim 12, wherein each filter rule further includes an action field that identifies the action to be performed on a packet in response to the packet matching the parameters included in the tuple for such filter rule.

16. The method of claim 12, wherein each filter rule further includes an index field that identifies those parameters among the plurality of parameters that are included in the tuple for such filter rule.

17. The method of claim 16, further comprising:
compiling a rule checking function for each filter rule, wherein the rule checking function for each filter rule is configured to test only those parameters among the plurality of parameters that are included in the tuple for such filter rule; and
generating a function table including a plurality of table entries indexed by the index field of each filter rule, each table entry configured to identify the rule checking function associated with an associated filter rule.

18. The method of claim 17, wherein the tuples for the filter rule set are stored in a tuple list, wherein each table entry in the function table includes a tuple length field identifying a length of the tuple associated with such table entry, the tuple length field for each table entry configured to be used to locate a next tuple in the tuple list upon a packet not matching the parameters specified in the tuple for the filter rule associated with such table entry.

19. An apparatus, comprising:
a memory configured to store a set of filter rules, wherein the filter rules in the set of filter rules include variable-length tuples; and
control logic coupled to the memory and configured to, in response to receipt of a packet, access a first filter rule among the set of filter rules from the memory and selectively perform an action on the packet based upon the first filter rule.

20. The apparatus of claim 19, wherein each filter rule in the set of filter rules specifies at least a subset of a plurality of parameters against which a packet is capable of being tested, wherein the tuple for each filter rule includes only those parameters against which a packet will be tested by such filter rule, and wherein the control logic is configured to test the packet against the parameters specifies by the first filter rule when selectively performing the action on the packet based upon the first filter rule.

21. The apparatus of claim 20, wherein each filter rule further includes an action field that identifies an action to be performed on the packet in response to the packet matching the parameters included in the tuple for such filter rule and an index field that identifies those parameters among the plurality of parameters that are included in the tuple for such filter rule, wherein the control logic is further configured to, after accessing the first filter rule, call a rule checking function identified by the index field for the first filter rule, and wherein the rule checking function is configured to test only those parameters among the plurality of parameters that are included in the tuple for the first filter rule.

22. The apparatus of claim 21, wherein the control logic is configured to call the rule checking function by accessing a function table indexed by the index field, the function table including a plurality of table entries, each entry including a pointer to a rule checking function.

23. The apparatus of claim 22, wherein the tuples for the set of filter rules are stored in a tuple list, wherein each table entry in the function table includes a tuple length field identifying a length of the tuple associated with such table entry, wherein the control logic is configured to call a rule search function to search for a matching filter rule in the set of filter rules, wherein the rule search function is configured to access the tuple length field of a table entry in the function table to identify a next tuple in the tuple list.

24. The apparatus of claim 20, wherein each of the plurality of parameters corresponds to a field in a packet, and wherein the plurality of parameters includes a source address, a destination address, a source port, a destination port, and a protocol.

25. A program product, comprising:
program code configured to filter packets by, in response to receipt of a packet, access a first filter rule among a set of filter rules and selectively perform an action on the packet based upon the first filter rule, wherein the filter rules in the set of filter rules include variable-length tuples; and
a computer readable medium bearing the program code.
